(19) United States
(12) Patent Application Publication
(10) Pub. No.: US 2015/0061836 A1
(43) Pub. Date: Mar. 5, 2015

(54) ASSIGNABLE SWITCH FOR PORTABLE DEVICES

(71) Applicant: Adam Eikman, Tampa, FL (US)

(72) Inventor: Adam Eikman, Tampa, FL (US)

(21) Appl. No.: 14/469,802

(22) Filed: Aug. 27, 2014

Related U.S. Application Data
(60) Provisional application No. 61/873,245, filed on Sep. 3, 2013.

(51) Int. Cl. G06K 7/10; G06K 7/00

(52) U.S. Cl. CPC G06K 7/10227; G06K 7/0008; G06K 7/10297; G06K 7/10386; G06K 2007/10524
USPC 340/10.3

(57) ABSTRACT

An RFID transponder comprising a manual switch is disclosed for use in close proximity with a mobile electronic device having an RFID transceiver, such as a telephone or a table computer. Actuating the manual switch causes the mobile device to perform a predetermined action. The predetermined action can be programed in the mobile device such that the effect on the mobile device of closing the manual switch depends on the programed state of the mobile device. The transponder acts as an additional programmable manual input and can be used, for example, to initiate a telephone call in a mobile phone or an application program in a phone or tablet computer.

### CROSS-REFERENCE TO RELATED APPLICATIONS

This utility application claims the benefit under 35 U.S.C. §119(e) of Provisional Application Ser. No. 61/873,245, filed on Sep. 3, 2013 and entitled Assignable Switch for Portable Devices. The entire disclosure of which is incorporated by reference herein.

### FIELD OF INVENTION

The invention relates to the field of portable electronic devices having provisions for interrogating near field communication transponders and other radio frequency identification-enabled devices

### BACKGROUND OF THE INVENTION

Portable electronic devices, such as smart phones and tablet computers, have become nearly ubiquitous accessories to modern life. These devices have gone far beyond simply providing mobile phone service, email and Internet access. They are sophisticated computers with high resolution interactive displays for which an enormous body of free or very inexpensive software application programs (commonly referred to as “apps”) are available. The increasing computing power of these devices has been accompanied by increasing functionality as semiconductor miniaturization continues to evolve. Mobile phones and the like now include global satellite positioning receivers, accelerometers, high resolution imaging cameras, and compasses. In addition to on-board functionality, a host of add-on devices have be developed for use with mobile phones and other portable electronic devices. These devices typically interface to the mobile device through a hard wired data port.

Recent additions to portable electronic devices include transceivers for RFID (radio frequency identification) transponders and more particularly Near-field communication (NFC) devices. RFID is a broad term covering wireless transponders from active devices used for electronic roadway toll collection to passive devices used for merchandise security. A subset of these radio frequency based devices is intended for use in very close proximity between the interrogator or reader and the transponder being read, typically a centimeter or less. These devices operate by inductive coupling as opposed to transmission and reception through traditional antennae.

Because of their portability and their presence in a large percentage of the population's pockets and pocketbooks, mobile phones and tablet computers can be used to read near field communication transponders because they can be easily placed near the device to be read. Thus an NFC transponder placed on an item of merchandise can be easily read by a consumer with an NFC-enabled mobile device, by placing the device next to the transponder and enabling the NFC electronics, typically through an application program. An advantage of a retailer placing an NFC transponder on a product as opposed to a bar code or QR code (which can also be read by many mobile devices) is that the NFC device can contain far more information than the optical code, which typically refers the reading device to a web site, and which requires the user to have internet connectivity to access information about the product. The NFC transponder can store a relatively large amount of information and provide it directly to the consumer without the consumer having internet connectivity on the spot.

One limitation of many mobile electronic devices is a lack of user interface hardware. By their nature, mobile devices have few user interfaces, since the majority of the user interaction through these devices is through the touch screen display. Hard push buttons and switches are limited to usually a dedicated on-off switch and perhaps a secondary dedicated switch for functions such as display wake-up, audio volume control, display orientation locking, etc. The wide range of available software programs for mobile computing devices could be greatly augmented with additional available user input means such as assignable push buttons. Typically, however, add-on devices interface through the mobile device's data port (if available), which can limit reliability and functionality as these connectors tend to be fragile and connecting an external device to them upsets the ergonomic design of the mobile device.

Thus a need exists for additional user input means for mobile devices in cases where the mobile device is also equipped with near field or other RFID communications capability. The subject invention addresses that need.

### BRIEF SUMMARY OF THE INVENTION

In one aspect of the invention there is a device for providing a manually activated signal input to a mobile electronic device having an RFID transceiver, the device includes an RFID transponder in communication with an electrical switch and the electrical switch is configured to alter a response state of the RFID transponder, and the device is further configured to be attachable to the mobile electronic device. In a further aspect of the invention, an electrical switch is configured to complete a circuit in the RFID transponder when the switch is closed. In a further aspect of the invention, the circuit that the switch closes includes an antenna. In further aspects of the invention, the transponder can be either a backscatter transponder, an active transponder or a near field communication transponder.

In any of the foregoing aspects of the invention the switch can be any of an electro-mechanical contact switch, a membrane switch, a capacitive or resistive touch sensor, a photo-sensitive switch, a reed switch and a Hall effect sensor.

In a further aspect of the invention, instead of the switch closing a circuit that included the antenna, the electrical switch is configured to provide an input signal to the RFID transponder.

In a further aspect of the invention, the transponder has a cover having a flexible portion configured to allow activation of electric switch. In an aspect of this version, the cover comprises a graphic design including a graphic indication of the flexible portion of the cover. In a further aspect of the invention, the cover comprises a tactile surface portion, in an area that when pressed causes activation of the electrical switch.

In a further aspect of the invention, the transponder is incorporated in a protective or decorative cover for a mobile device.

A further aspect of the invention is a mobile electronic system that includes a mobile electronic device having an RFID transceiver and an RFID transponder attached to the mobile electronic device, where the RFID transponder is in communication with an electrical switch, and wherein said electrical switch is configured to alter a response state of the RFID transponder, and wherein the RFID transceiver is configured to detect the altered response state.

In a further aspect of the system invention, the mobile electronic device is configured to perform an action based on said altered state of said RFID transponder. The said action can be, for example: initiating a telephone call; starting a predetermined application program; taking a photograph, illuminating a light producing element or producing an audible response.

In a further aspect of the system invention, the mobile electronic device is arranged to be re-configured to allow a different action to take place based on said altered state of the RFID transponder.

In a further aspect of the system invention, the RFID transponder has a plurality of switches, each switch being configured to produce a different RFID response and the mobile electronic device is adapted to be programmed to respond with an action associated with each of the plurality of switches.

A further aspect of the invention is a method of controlling a mobile electronic device system comprising a mobile device having an RFID transceiver and an assignable RFID transponder having a switch. The method includes the steps of placing the RFID transponder in proximity to the mobile device such that the RFID transceiver in the mobile device can receive a signal from the RFID transponder; manually closing the switch on the RFID transponder; scanning by the mobile telephone RFID transceiver to interrogate any available RFID transponders; reading information from the RFID transponder by the mobile device RFID transceiver; and performing a predetermined action by the mobile device based on said RFID transponder switch being closed.

In a further aspect of the method invention, the steps are included of manually opening the switch on the RFID transponder after said closing and performing a second predetermined action by said mobile device based on said opening of the switch.

In a further aspect of the method invention, the predetermined action performed by the mobile device can be any of initiating a telephone call; initiating a macro; starting a predetermined application program; taking a photograph, illuminating a light producing element or producing an audible response. Actions can optionally be associated with a combination of a button press with time, location or phone state. For example a button press may be associated with initiating a telephone call to different phone numbers depending on time of day, location, or velocity. As another example, the orientation of a portable device as determined by on board sensors in conjunction with a button press could determine the actions of recording a video or taking a picture depending on if the phone is horizontal or vertical. In a further example, pressing a button while the portable device is “paired” with a device such as the onboard computer of a car, could also serve to augment the assigned action. In a further aspect of the method invention, the mobile device performs more than one operation based on the RFID switch being closed, the operation depending on a state of the mobile device.

### BRIEF DESCRIPTION OF SEVERAL VIEWS OF THE DRAWINGS

FIG. 1 is an isometric view of an exemplary mobile device, e.g., a mobile phone, on which one exemplary embodiment of an assignable RFID switch constructed in accordance with this invention is mounted;

FIGS. 2a-2c are plan views of three layer portions of the exemplary assignable RFID switch shown in FIG. 1;

FIG. 3 is a plan view of an alternate embodiment of a layer of the assignable RFID switch of FIG. 2;

FIG. 4 is a flow diagram of an exemplary process for use of an assignable RFID switch constructed in accordance with this invention; and

FIG. 5 is an isometric view of an exemplary embodiment of an assignable switch constructed in accordance with this invention shown incorporated in a case for a mobile phone.

### DETAILED DESCRIPTION OF PREFERRED EMBODIMENTS OF THE INVENTION

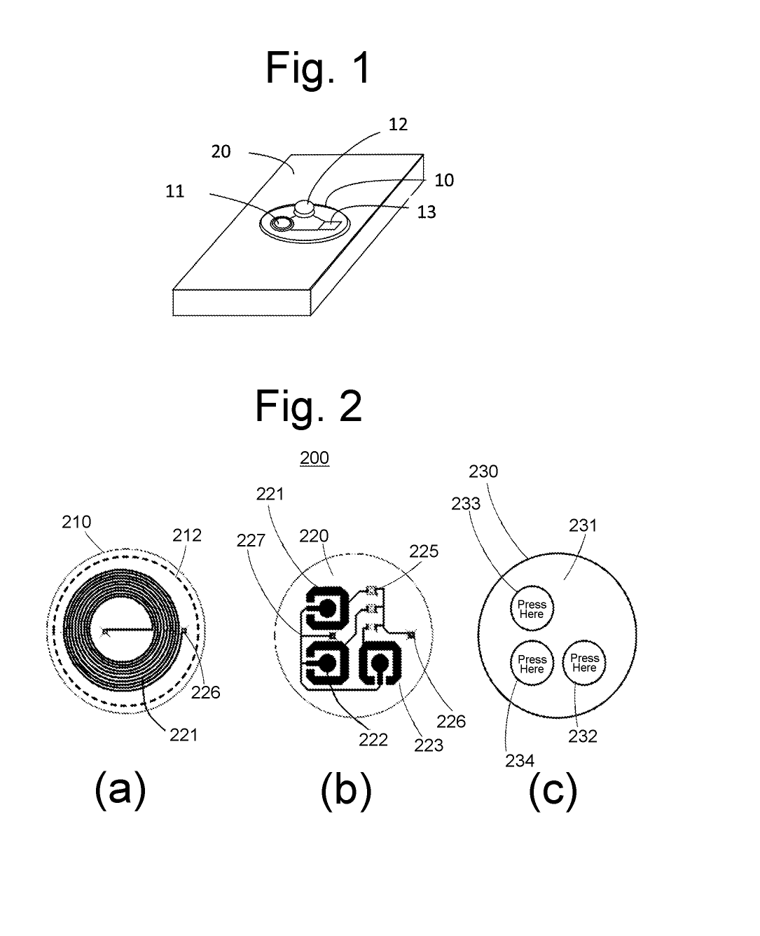

With respect to FIG. 1, there is shown an exemplary embodiment of an assignable switch device 10 that communicates with a mobile device (such as a cell phone, tablet, etc.) 20 via near field communication (NFC). The device 10 comprises one or more push button switches 12, an antenna or inductor 11 and an integrated circuit 13, mounted on a circuit board. One side of the device has a push button 12 and the other side includes a pressure sensitive adhesive 14 affixed thereto and configured to attach the device 10 to the mobile device 20 within proximity of an RFID reader or sensor that is part of the mobile device.

In one exemplary embodiment, the assignable switch is attached to the back of a smartphone or other mobile device 20 that includes a transceiver (not shown) that is compatible with NFC standards, which are a subset of RFID technology. At present, several existing standards relate to the broader category of RFID devices. These include ISO/IEC 14443 and FeliCa, while one NCF-specific standard is ISO/IEC 18092. The invention is not limited to the use of existing electromagnetic and protocol standards. What is relevant to the invention is that the assignable switch device is electromagnetically compatible with the NFC or RFID transceiver in the mobile device and that the two devices operate with compatible communications protocols.

With respect to FIG. 1 and FIG. 4, which shows an exemplary method of use, at step 410, the user presses the push button 12 on the assignable switch to activate the device. Once the switch is closed, the assignable switch device becomes operable. In this state, the assignable switch 10 can be recognized by the mobile device 20 when the mobile device attempts at step 420 to interrogate for available RFID devices in its proximity. At Step 430, a signal is detected by the mobile device's RFID hardware. At Step 440, the operating system or firmware in the mobile device reads the signature of the assignable switch. Once the switch is recognized by the mobile device, it's closed state is used by higher level software at Step 450 on the mobile device which has been previously set up to accept the assignable switch actuation as a program input. Examples of programs that could be configured to cause an action to occur based on the closing of the assignable switch include taking a picture, using the phone as a flashlight, running macros, opening a URL, acting as a speed dial button, or opening a preferred application. Thus, the assignable switch serves as a shortcut to opening the mobile device's touch screen and navigating to a desired application or action. In addition, since the assignable switch is tactile, it can serve as an alternate method of user input to the mobile device for the visually impaired.

With respect to FIGS. 2(a)-2(c), there is shown an exemplary embodiment of an assignable switch device 200 having three separate switches. As shown in therein, the device can be constructed in three flexible layers 210 (FIG. 2(a)), 220 FIG. 2(b)) and 230 (FIG. 2(c)) that are stacked and bonded. The bottom layer of a flexible circuit board is designated by the reference number 210 and comprises an antenna 211 and an adhesive layer 212. The middle layer flexible circuit board 220 comprises a multiplicity of RFID integrated circuits 225 which share a connection 226 to the single antenna 211. Corresponding to the number of RFID integrated circuits are an equal number of metal dome switch circuit pads 221, 222, 223, each connected to one of the RFID integrated circuits 221 and all three of the switch pads are connected via a second connection 227 to the antenna 211. The top layer 230 comprises a flexible film 231 having embossed buttons 232, 233, 234 which house the metal domes (not shown). Each metal dome is configured to close a respective one of the switches 221, 222, 223 on layer 220. The top layer 230 is ideally a flexible material that can accept printed graphics such as shown in FIG. 2(c) labeled “Press Here” or which can be textured in the area of the switch domes to provide additional tactile feedback to the user, who can then locate and operate one of the switches without necessarily seeing it.

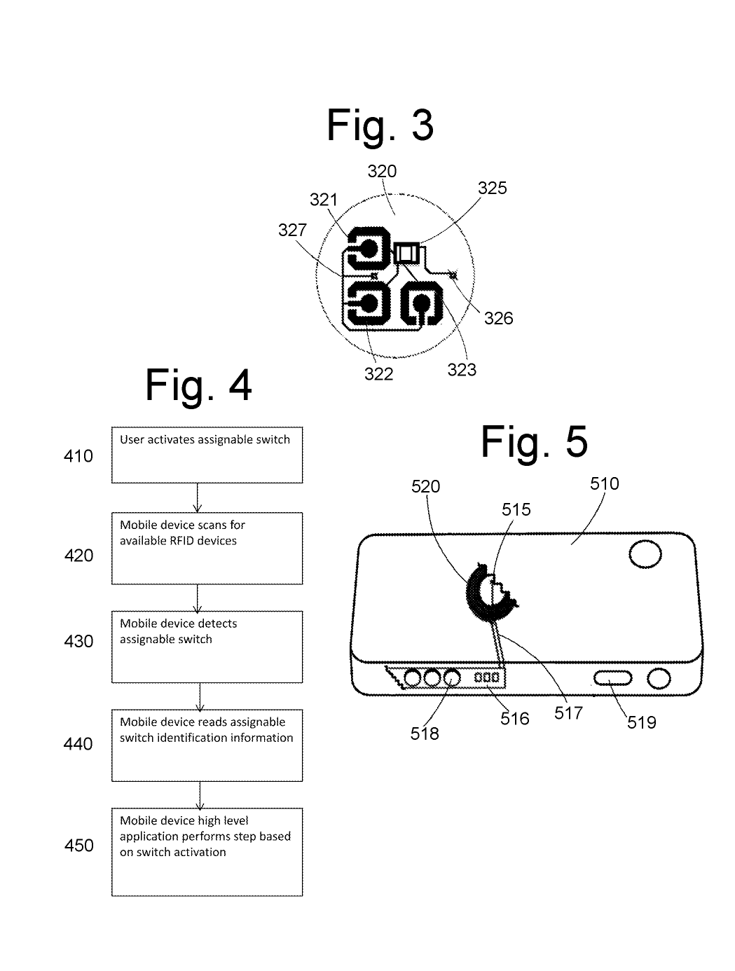

In a further embodiment of the device, a single RFID integrated circuit contains multiple identification numbers or other identifiers. In one such embodiment, shown in FIG. 3, switches 321, 322, 323 each connect a specific part of the RFID integrated circuit 325 to the antenna connection 327. FIG. 3, is a middle layer that could be inserted between layers 210 and 230 instead of layer 220 in FIG. 2. In FIG. 3, the three switches each connect to separate contacts on a single RFID integrated circuit. In a further exemplary embodiment, the integrated circuit is always connected to both terminals of the antenna and the switches connect other elements of the integrated circuit together. Such an arrangement would be useful for allowing the device to produce more output responses than the number of switches, by allowing a plurality of switches to be pressed simultaneously.

In an alternative exemplary embodiment, the RFID integrated circuits can be made sufficiently small to be built into the button mechanism itself.

The assignable switch device of this invention can be either a passive powered device that harvests energy via its antenna or a battery powered RFID circuit. An internally powered RFID circuit can have a faster response than a passive device and would have a reduced latency between switch activation and sensing by the mobile device. Such reduced latency would be more suitable to time sensitive applications, such as gaming or stopwatch programs. Regardless of the form of power, the transponder can be any of a backscatter transponder, an active transponder or a near field communication transponder.

It should be pointed out at this juncture that the invention is not limited to electro-mechanical contact-type switches as described above. Thus, the switch can be any type, e.g., a membrane switch, a Hall Effect sensor, a reed switch, a flip switch, a knife switch, a pin and hole, various momentary switches, or even a lock and key which closes a circuit. A capacitive or resistive switch is also an option. The broad range of switches that could be utilized also serves as a form of personalization. In addition, one could extrapolate not only switches triggered by human interaction but also changes in the environment such as a temperature switch that is assigned to applications. The functional equivalent of a switch in the circuitry of the invention could be achieved with a push button which when actuated augments the distance of a material (that interferes with the function of the antenna), to the antenna. With such an arrangement, there is no need for a switch in the circuitry of device.

The many available configurations of mobile phones, tablet computers and the like, suggest a wide range of applications for the assignable switch device of the present invention. For example, the device could be embedded into a cell phone cover as a single or multiplicity of buttons, in the formation of a gamepad or an instrument. For example, FIG. 5 shows a perspective view of a smartphone case 510 with an exemplary RFID assignable switch 515 embedded therein as shown in the cut-away view of the case material. This example allows the antenna 520 to be located optimally for reception by the smartphone' s RFID transceiver (not shown). The circuit board of the assignable switch 516, with the push-button switches 518, can be located around the sides of the case 519 and connect to the antenna 520 with conductors 517.

Because the device can require proximity and manual activation, the use as a security feature is suggested. For example, many banks now use mobile device application programs (apps) to correspond with their clients. The addition of a switched RFID device adds additional security by allowing devices with only the associated RFID assignable switch to access a particular account. This serves as two-step verification over the customary single step of requiring entry of a user identification and password.

The assignable switch device of this invention also has utility as a marketing tool. In this regard, it is well known that once installed apps are often quickly forgotten. With an assignable switch device of this invention one can provide quick access to a particular app. Thus, by use of this invention the app developer increases the odds that its software will be used. In addition, the device can be labeled as shown in FIG. 2(c) or otherwise branded to increase awareness amongst consumers. To enable mass customization and personalization, a website could allow for customization using online drawing tools or the upload of images. These images could be displayed on the device overlay 231 in FIG. 2 and the associated switch buttons 232, 233, 234.

Those skilled in the art will recognize other detailed designs and methods that can be developed employing the teachings of the present invention. The examples provided here are illustrative and do not limit the scope of the invention, which is defined by the attached claims.

What is claimed is:

1. A device for providing a manually activated signal input to a mobile electronic device having an RFID transceiver, the device comprising:
an RFID transponder in communication with an electrical switch,
wherein said electrical switch is configured to alter a response state of said RFID transponder, and wherein the device is configured to be attachable to the mobile electronic device.

2. The device of claim 1, wherein said electrical switch is configured to complete a circuit in said RFID transponder when closed.

3. The device of claim 2, where said circuit includes an antenna.

4. The device of claim 1, wherein said RFID transponder is selected from the group consisting of: a backscatter transponder, an active transponder and a near field communication transponder.

5. The device of claim 1, wherein said electrical switch is selected from the group consisting of an electro-mechanical contact switch, a membrane switch, a capacitive touch sensor, a photo-sensitive switch, a reed switch and a Hall effect sensor.

6. The device of claim 1, wherein said electrical switch is configured to provide an input signal to said RFID transponder.

7. The device of claim 1, further comprising a cover having a flexible portion configured to allow activation of said electric switch.

8. The device of claim 7, wherein said cover comprises a graphic design including a graphic indication of said flexible portion of said cover.

9. The device of claim 7, wherein said cover comprises a tactile surface portion, in an area that when pressed causes activation of said electrical switch.

10. The device of claim 1, wherein the device is incorporated in a protective or decorative cover for said mobile device.

11. A mobile electronic system comprising:
a mobile electronic device having an RFID transceiver and
an RFID transponder attached to said mobile electronic device, said RFID transponder being in communication with an electrical switch,
wherein said electrical switch is configured to alter a response state of said RFID transponder, and wherein said RFID transceiver is configured to detect said altered response state.

12. The mobile electronic system of claim 11, wherein said mobile electronic device is configured to perform an action based on said altered state of said RFID transponder.

13. The mobile electronic system of claim 12, wherein said action is selected from the group consisting of: initiating a telephone call; starting a predetermined application program; taking a photograph, illuminating a light producing element and producing an audible response.

14. The mobile electronic system of claim 12 wherein said mobile electronic device is arranged to be re-configured to allow a different action to take place based on said altered state of said RFID transponder.

15. The mobile electronic system of claim 12, wherein said RFID transponder has a plurality of switches, each switch being configured to produce a different RFID response and wherein said mobile electronic device is adapted to be programmed to respond with an action associated with each of said plurality of switches.

16. The mobile electronic system of claim 12, wherein said mobile electronic device is configured to perform a first action upon said altered state of said RFID transponder and a first state of said mobile electronic device and to perform a second action upon said altered state of said RFID transponder and a second state of said mobile electronic device.

17. A method of controlling a mobile electronic device system comprising a mobile device having an RFID transceiver and an assignable RFID transponder having a switch, said method comprising:
a) placing the RFID transponder in proximity to the mobile device such that the RFID transceiver in the mobile device can receive a signal from the RFID transponder;
b) manually closing the switch on the RFID transponder;
c) scanning by the mobile telephone RFID transceiver to interrogate any available RFID transponders;
d) reading information from the RFID transponder by the mobile device RFID transceiver; and
e) performing a predetermined action by the mobile device based on said RFID transponder switch being closed.

18. The method of claim 17, further comprising:
f) manually opening the switch on the RFID transponder after said closing; and performing a second predetermined action by said mobile device based on said opening of the switch.

19. The method of claim 17, wherein said predetermined action is selected from the group consisting of initiating a telephone call; starting a predetermined application program; taking a photograph, illuminating a light producing element and producing an audible response.

20. The method of claim 17 wherein said predetermined action is based on a state of the mobile electronic device.
